(19) United States
(12) Patent Application Publication
(10) Pub. No.: US 2018/0074464 A1
(43) Pub. Date: Mar. 15, 2018

(54) Digital Display With Coordinated Analog Information Indicators

(71) Applicant: Timex Group USA, Inc., Middlebury, CT (US)

(72) Inventors: Thomas Essery, Rockfall, CT (US); Brian Pemberton, Causeway Bay (HK)

(21) Appl. No.: 15/260,655

(22) Filed: Sep. 9, 2016

(51) Int. Cl. G04G 9/00; G04B 19/04

(52) U.S. Cl. CPC G04G 9/0064; G04B 19/04

(57) ABSTRACT

A wearable electronic device having at least one analog information indicator; a digital display for displaying information; at least one actuation mechanism, coupled to the at least one analog information indicator, for rotating the at least one analog information indicator in at least one of a clockwise and counterclockwise direction; and a controller, operatively coupled to the at least one actuation mechanism and the digital display, for coordinating the positioning of the at least one analog information indicator based on the information being displayed on the digital display. A method of facilitating the display of information on a digital display of a wearable electronic device is also provided.

### BACKGROUND OF THE INVENTION

The present invention is directed to wearable electronic devices generally, and in particular, to a wearable electronic device comprising at least one analog information indicator, a digital display for displaying information, and a controller for coordinating the positioning of the at least one analog information indicator based on the information being displayed on the digital display. Specifically, the present invention incorporates a controller that coordinates the positioning of the analog information indicator(s) to create unobstructed viewing “sections” on the digital display, thereby providing that the analog information indicator(s) does/do not overlie or obscure information being provided on the digital display.

Timepieces that include both analog and digital displays are well-known in the art. For example, U.S. Publication No. 2005/0243653 references a watch style in which an LCD layer is provided above analog dial/hands, wherein analog hands display the time while the LCD displays the date, while U.S. Publication No. 2005/0243653 itself describes the use of analog hands positioned on top of an underlying LED “secondary display.” U.S. Patent Publication No. 2007/0014193 describes a versatile wearable electronic device in which a LCD is provided and an indicator hand is further provided that points to differing informational indicia being displayed on the LCD.

Specific control over the analog information indicators is also known to exist, and is described in such prior art as the aforementioned U.S. Patent Publication No. 2007/0014193, and incorporated into timepieces manufactured by Timex and Tissot, both of which provide timepieces with controllable moving hands. However, such timepieces have primarily been directed to the controlling of the analog hands for purposes other than for that disclosed herein.

Thus, perceived deficiencies still exist in the art. For example, to date, it is believed that the state of the art is deficient in providing a timepiece in which the hands/indicators are intentionally moved and positioned by the controller to maximize the view ability of the digital display and provide for the unobstructed view of the information being provided thereon. In addition, using the analog indicators to improve the viewability of the digital display and the information provided thereon is also a deficiency in the prior art. In particular, the prior art is deficient in being able to intentionally minimize the viewable interference that oftentimes is created by the position of analog hands or indicators when digital display information is being conveyed to the user.

It is thus believed that further advances to the state of the art are both desirable and achievable. In particular, it is desirable to provide a timepiece in which there is control of the positioning of the at least one analog information indicator based on the information being displayed on the digital display.

It is also desirable to provide methodologies to carry out the foregoing functionality.

### SUMMARY AND OBJECTIVES OF THE INVENTION

It is thus an objective of the present invention to overcome the perceived deficiencies in the prior art.

Specifically, it is an objective of the present invention to provide a wearable electronic device that provides for the intentional movement and positioning of the analog information indicator(s) based on the information being displayed on the digital display, all in an effort to maximize the viewability of the information being displayed thereon, to create unobstructed viewing “sections” on the digital display, and improve the overall readability of the information being displayed on the digital display.

Still a further objective of the present invention is to provide methodologies for carrying out and/or facilitating the foregoing.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

Therefore, to overcome the perceived deficiencies in the prior art and to achieve the objects and advantages set forth above and below, a preferred embodiment of the present invention is, generally speaking, directed to a wearable electronic device comprising at least one analog information indicator; a digital display for displaying information; at least one actuation mechanism, coupled to the at least one analog information indicator, for rotating the at least one analog information indicator in at least one of a clockwise and counterclockwise direction; and a controller, operatively coupled to the at least one actuation mechanism and the digital display, for coordinating the positioning of the at least one analog information indicator based on the information being displayed on the digital display.

In another preferred embodiment, the invention is directed to a method of facilitating the display of information on a digital display of a wearable electronic device, wherein the electronic device comprises at least one analog information indicator; a digital display for displaying information; at least one actuation mechanism, coupled to the at least one analog information indicator, for rotating the at least one analog information indicator in at least one of a clockwise and counterclockwise direction; and a controller, operatively coupled to the at least one actuation mechanism and the digital display, for coordinating the positioning of the at least one analog information indicator based on the information being displayed on the digital display; wherein the method comprises the steps of rotating the at least one analog information indicator in one of a clockwise and counterclockwise direction and positioning said indicator based on the information being displayed on the digital display; wherein at least two (2) sections are created in a viewable area of the digital display; and the position of the at least one analog information indicator is such that it does not overlie or obscure the information being provided on the digital display.

In a preferred embodiment, the electronic device is a timepiece in the form of a wristwatch, although it could be perceived that a wall clock, dials in a car or other displays using analogue indicators could also have similar technologies and benefits to the user.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 illustrates a wearable electronic device in accordance with a first preferred embodiment of the present invention, shown in partial cross-section, illustrating a digital display positioned below one or more analog information indicators;

FIG. 2 is a perspective view of block diagram showing motors and a generic gear assembly G1 for a movement assembly for a wearable electronic device constructed in accordance with all the embodiments disclosed herein, wherein the position of the motors M1, M2, M3 and M4 as well as the size and position and other parameters of the gearing assembly or assemblies associated with each motor to rotate a respective indicator would be one of design choice and well within the purview of one skilled in the art;

FIGS. 3-5 are block diagrams showing among other things, a controller for use in wearable electronic devices constructed in accordance with all the preferred embodiments of the present invention;

FIG. 6 illustrates a wearable electronic device in accordance with another preferred embodiment of the present invention, shown in partial cross-section, illustrating a digital display positioned above one or more analog information indicators.

FIG. 7 illustrates a wearable electronic device in accordance with the preferred embodiments of the present invention, showing exemplary positioning of analog information indictors to create sections of the digital display defined by the position(s) thereof, wherein at least two (2) sections (e.g. upper and lower) are created in a viewable area of the digital display, further showing that the sections of the digital display each provide information to a user of the wearable electronic device and that the position of the analog information indicator(s) is/are such that it/they do not overlie or obscure the information being provided on the digital display.

FIG. 8 illustrates a wearable electronic device in accordance with the preferred embodiments of the present invention, also showing exemplary positioning of analog information indictors to create sections of the digital display defined by the position(s) thereof, wherein at least two (2) sections (e.g. right and left) are created in a viewable area of the digital display, also showing that the sections of the digital display each provide information to a user of the wearable electronic device and that the position of the analog information indicator(s) is/are such that it/they do not overlie or obscure the information being provided on the digital display;

FIG. 9 illustrates a wearable electronic device in accordance with the preferred embodiments of the present invention, showing further exemplary positioning of analog information indictors to create yet additional sections of the digital display defined by the position(s) thereof, wherein at least two (2) sections (e.g. upper and lower) are created in a viewable area of the digital display, and further showing a third analog information indicator that is positioned to create yet a 3^{rd} section defined by the positions thereof (e.g. showing the third analog information indicator point to a conventional 12 o'clock position of a watch dial, thereby dividing the upper section additionally into right and left sections;

FIG. 10 is a top plan view of the wearable electronic device in FIG. 1; and

FIGS. 11A-11D illustrate another advantage feature of the present invention.

Identical reference numerals in the figures are intended to indicate like parts, although not every feature in every figure may be called out with a reference numeral.

Depending on the number of hands on the analogue movement 2, 3, 4 or more sections on the digital display could be created.

### DETAILED DESCRIPTION OF THE PREFERRED EMBODIMENTS

Generally speaking, the present invention and the preferred embodiments thereof are directed to a wearable device, and preferably in the form of a timepiece and a wristwatch in particular, in which controllable moving hands in the timepiece appear over the top of a full or partial digital watch dial or under a digital display integrated with watch crystal. The watch dial or watch crystal (wherever the digital display is implemented) is capable of providing information to the user in a similar way to any regular digital display. However, without the implementation of the present invention, the hands of the watch have the potential to “get in the way” of the display, making the reading of the display more difficult.

Therefore, in accordance with the present invention, the movement of the watch hands is coordinated directly with the digital display where the movement of the hands create “sections” of the viewable area of the digital display and align with the borders of the sections of the digital display, which has the advantageous effect of creating natural boundaries and “hiding” the hands along the boundaries (and thereby not obscuring information on the digital display).

For example, and as further disclosed herein, the hour and the minute hands of the electronic device can form a straight line, e.g. from 3 to 9 o'clock, effectively cutting the digital dial in half. The digital dial can then use this “natural break” (e.g. line) to display two pieces of information, on top or below the line created by the watch hands. Moreover, the information could be displayed in different colors, depending on the capabilities of the display used. Once the feature on the digital display is finished being displayed, the watch hands can return to their regular use of telling the time, if they function as such.

Further advantages of the foregoing inventive embodiments can be appreciated using additional analog indicators (e.g. watch hands). For example, three hands from a central stem can split the screen into three (3) sections, while four (4) hands could further split the watch face into four (4) segments and the digital display can be split accordingly.

As will also become clear, one or more of the analog indicators can be moved to one location (e.g. all pointing to the 12 o'clock position) to free up more viewing space for the digital dial or watch glass.

In addition, the analog indicators could be further used to point to relevant or otherwise particular information on the digital display.

As will be disclosed and understood herein, the advantages and features of the present invention may be achieved via a combination of a digital display (either implemented as a watch dial or part of a watch dial with the display located between the top of the movement and below the watch hands or as a transparent or semi-transparent display integrated with watch crystal located above both the dial and the hands) and a watch movement that has control of the hands. Control of the hands is achieved via a number of micro motors driving the hands and software in the watch to coordinate the interaction between the display and the hands, the details of which will now be disclosed.

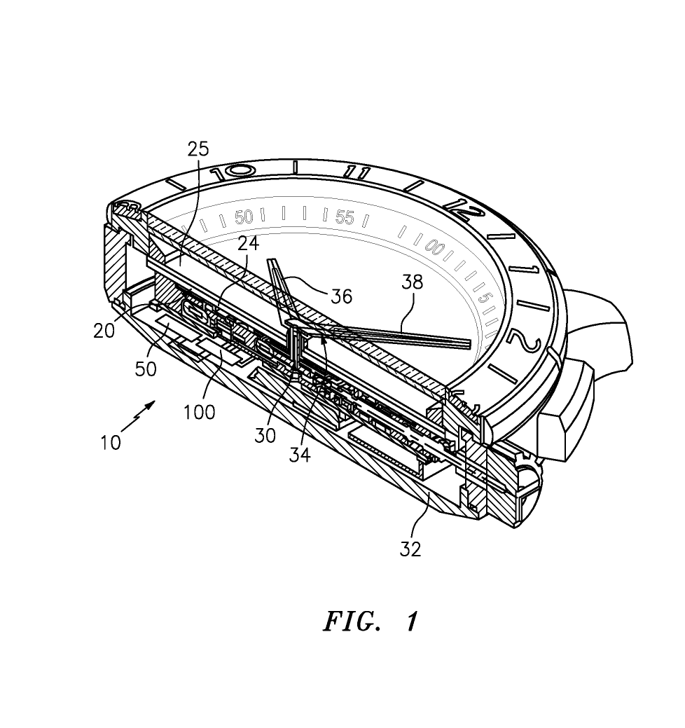

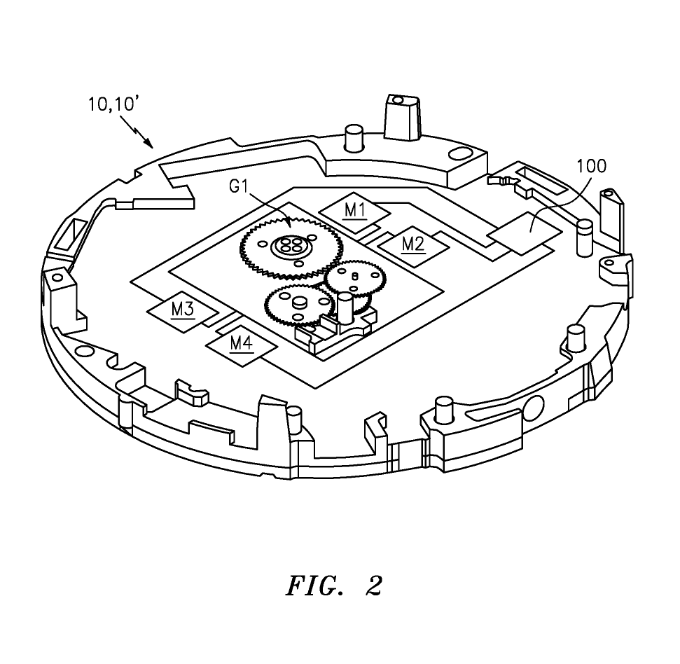

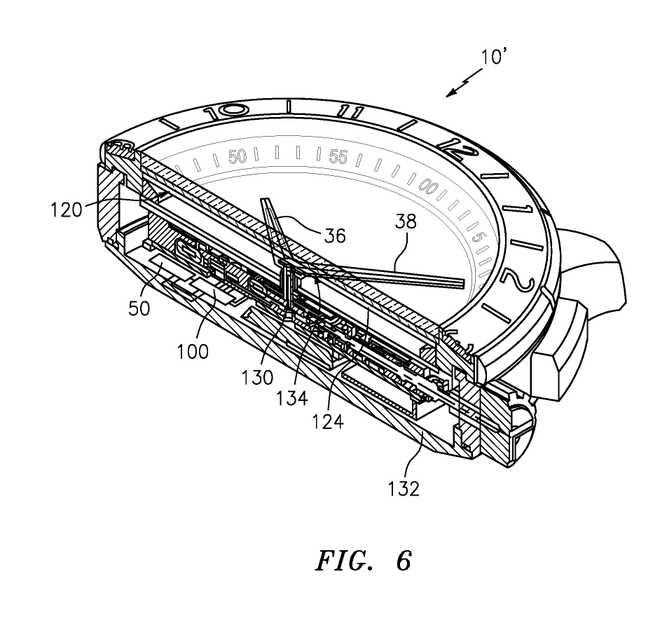

It should first be understood that FIG. 1 is somewhat particular to a first preferred embodiment of the present invention, in which the wearable electronic device comprises a digital display assembly provided below the analog display assembly. FIG. 6 is somewhat particular to a preferred embodiment of the present invention in which the digital display assembly is provided above the analog display assembly. FIGS. 2-5 and 7-9 illustrate features, functionality and constructions that are common to all embodiments disclosed herein.

Therefore, reference will first be made to FIG. 1, which illustrates a wearable electronic device, generally indicated at 10, constructed in accordance with a first embodiment of the present invention, in which the digital display assembly is provided below a dial 25 and the analog display assembly. In an alternative embodiment, the LCD may act as the dial itself.

Moreover, because the device 10 knows where the hands are and what is displayed on the screen, it would also be possible to change the location of some information appearing permanently on the dial, so it would never be obscured by the hands. For example, weather report appearing on the dial could move down as the minute hand approaches, then move to above the hand as the minute hand passes. Alternatively, device 10 may have compass functionality, wherein the hands are used to create a compass. Here, as the user rotates the device, the digital dial will know where the hands are and therefore adapt the message/information accordingly, i.e. in this case in the direction the hand is pointing to. Thus, once “true North” is pointed at the digital dial could display a pattern or arrows to indicate that this is the “true North” heading. Again, the important feature is that the hands and dial interact together, never having the hand obscure the message on the dial.

Thus, in accordance with any of these embodiments, electronic device 10 comprises a digital display assembly, indicated generally at 20, comprising a digital display 24, which is preferably of the LCD or OLED type, by way of example and not limitation. An analog display assembly, generally indicated at 30, is provided in a case or housing 32. An analog display, generally indicated at 34, is part of analog display assembly 30.

According to an exemplary embodiment of the present invention, digital display 24 may be a twisted nematic type liquid crystal cell or an electrophoretic display, such as those developed by e-ink. But other types of displays are equally applicable as would be understood by those skilled in the art. It is also well known in the art how to program and arrange for a controller, such as controller 100 as disclosed herein, to control the display of information on the digital display 24.

In preferred embodiments of the present invention, analog information indicators 36, 38 may be used for time information (e.g. “time of day”), but other information may be displayed and/or conveyed by the use of the analog indicator hands 36, 38, examples of which may be found in U.S. Pat. No. 7,113,450, entitled “Wearable Electronic Device With Multiple Display Functionality,” the subject matter of which is incorporated by reference as if fully set forth herein. In any event, the construction of an analog display assembly should also be known to those skilled in the art and therefore, the present disclosure omits, for purposes of brevity, certain basic and very well-known concepts regarding the construction of analog timepieces. For example, the basic construction and arrangements of gears and/or gear trains to rotate a plurality of “standard” hands all supported on a center stem, such as an hour hand and a minute hand, are omitted as being well within the purview of one skilled in the art.

However, for completion, the following is set forth for the convenience of the reader. In order to carry out all the functionality set forth and/or contemplated herein, wearable electronic device 10 may be provided with one or more subassemblies, each of which may comprise at least one actuation mechanism and one or more gears rotateably engaged with the actuation mechanism, wherein actuation of the actuation mechanism causes the rotation of the one or more gears. As discussed herein, the preferred actuation mechanisms are stepper motors. As would be understood, the rotation of only a minute hand and an hour hand typically requires only one stepper motor, but to maximize the functionality of the present invention, each analog information indicator preferably has associated therewith its own respective motor. The figures illustrate motors M1, M2, M3 and M4 which may be used to rotate respective analog information indicators as would be understood in the art. As would be understood in the art, the specific location of such motor(s) is one of design choice and dictated by constraints such as spacing, power and torque requirements and the desired positioning of the analog indicators. As would also be understood in the art, the specific location, size, ratio, etc. of the gears or gearing assemblies associated with each of such motor(s) to rotate a respective indicator is also one of design choice and dictated by constraints such as spacing, power and torque requirements and the desired positioning of the analog indicators. As positioned, the respective motors rotate respective pinions as would be understood in the art. As an exemplary configuration, motor M1 is provided to rotate analog information indicator 36, motor M2 is provided to rotate indicator 38, motor M3 is provided to rotate indicator 39 and motor M4 is provided to rotate indicator 37, each through respective gear trains, as should also be understood by those skilled in the art.

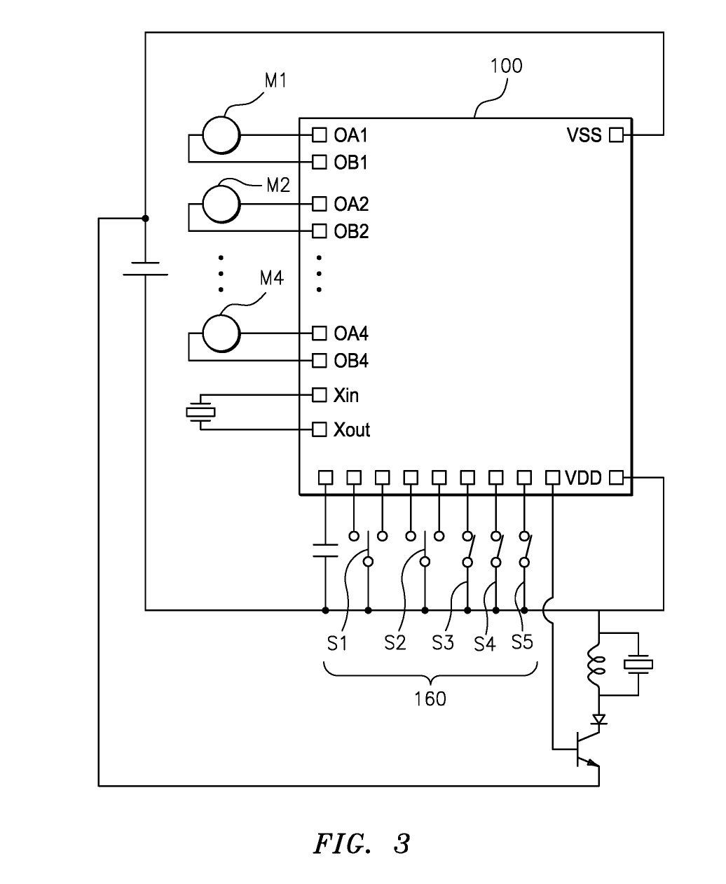

FIGS. 3-5 illustrate many additional features in accordance with the present invention, including details of controller 100 for providing the proper and accurate controlling, positioning and rotation of the one or more analog information indicators. Many details of controller 100 can be found in the aforementioned U.S. Pat. No. 7,113,450 by reference to controller 100, and the controller 100 of the present invention preferably comprises all of the functional features described therein to carry out the objectives and features of the present invention. Added functionality particular to the present invention is also disclosed herein.

For example, FIGS. 3-5 illustrate among other things, interface connections to motors M1, M2, M3 and M4, as well as pushers, which are illustrated schematically as switches S1-S5. However, it is understood that the switches are also intended to generically indicate both side/top mounted pushers 160, as well as side mounted rotatable crowns, and thus respond to the actuation (i.e. pulling and/or pushing) action thereof. As would be understood with a conventional digital wristworn device, actuating of one of the pushers may cause the device 10, 10′ to enter the various (e.g. fitness, message retrieval, reminders, phone answering, etc.) modes as disclosed and/or contemplated herein.

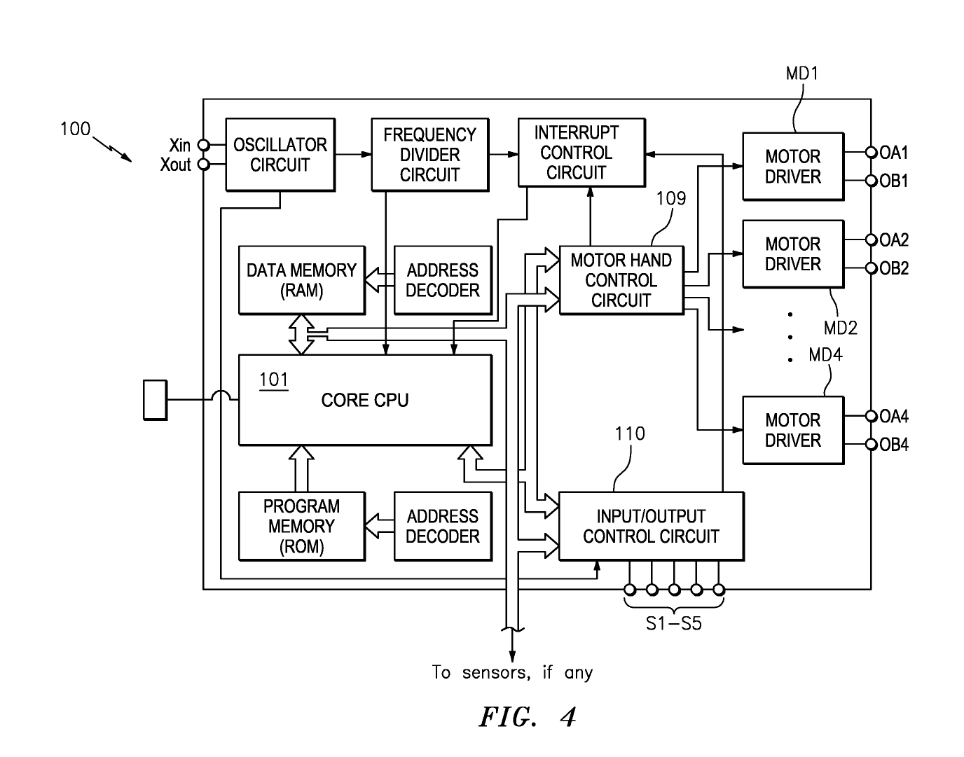

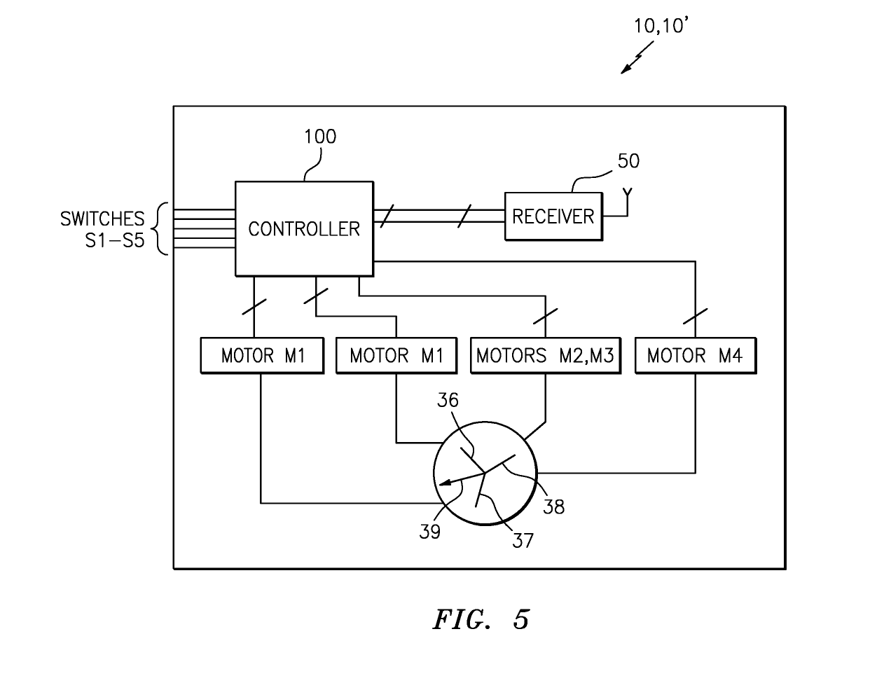

FIGS. 4 and 5 illustrate block diagrams, including of controller 100. Particular reference is made to motor control circuit 109, which receives a commanded “next number of pulses” from CPU core 101 and generates the pulsed and phased signals necessary to move a desired motor (e.g. M1, M2, M3 and/or M4) a desired amount and in a desired direction. Pulse outputs of motor control circuit 109 are buffered by motor drivers MD1-MD4 and applied to the respective motors M1, M2, M3, M4, etc. as the case may be. An input/output control circuit 110 can controls any crown/stem actuations and/or pushbutton switches S1-S5 and provides such signaling information to CPU 101.

As would be understood in the art and exemplary shown in the figures, the actuation mechanism(s) (e.g. stepper motor M1, M2, M3 and/or M4) comprises a rotor, and is/are operatively coupled to controller 100, wherein the stepper motor steps in at least one of a clockwise and counterclockwise direction in predefined increments in response to commands from the controller 100, wherein the rotor of each stepper motor is operatively coupled to its respective analog information indicator, and wherein the rotation of rotor causes the rotation of the respective analog information indicators in at least one of the clockwise and counterclockwise directions and in the predefined increments.

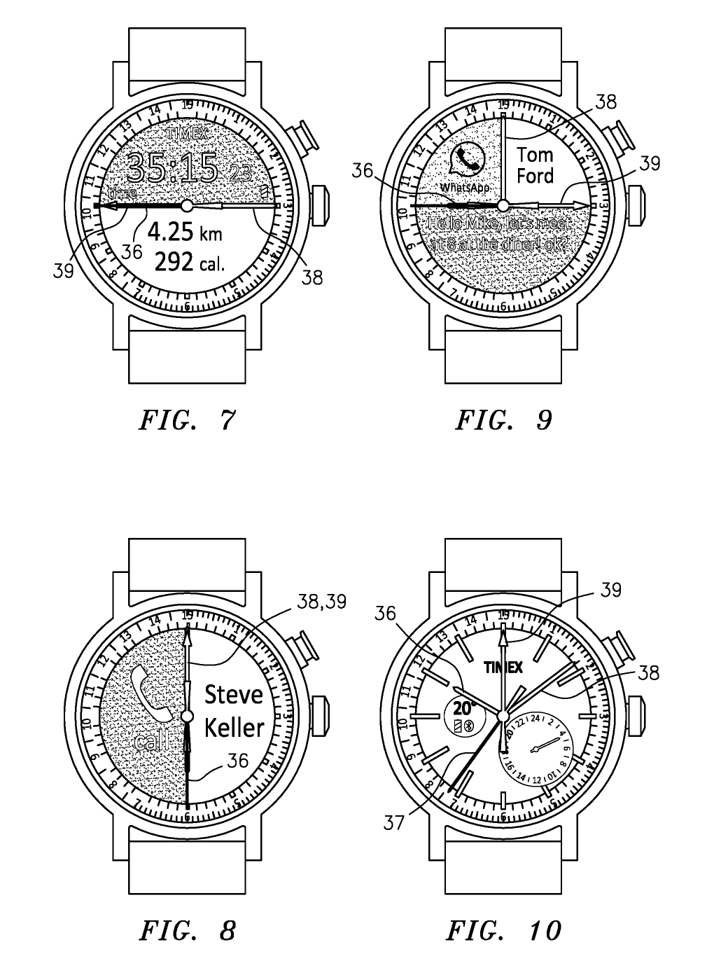

As noted in FIGS. 7-10, the digital display may display a wide variety of information, including, but not limited to, speed/distance, elapsed time, phone messages, incoming call information including the calling party, reminders, among many other informational messages and indicia. As such, it is preferable that wearable electronic device 10 comprises a receiver as indicated generically at 50 (see FIGS. 1, 5, 6). Receiver 50 is intended to generically indicate the receiving means to carry out all functionality as needed to receive GPS data, phone data, and other sensory data that may be received by device 10.

Reference is next briefly made to FIG. 6 which is directed to a wearable electronic device, generally indicated at 10,′ constructed in accordance another preferred embodiment of the present invention. For example, FIG. 6 illustrates a wearable electronic device in which the digital display assembly is provided above the analog display assembly.

In accordance with this embodiment, device 10′ similarly comprises a digital display assembly, indicated generally at 120, comprising a digital display 124, which is preferably also of the LCD or OLED type, by way of example and not limitation. An analog display assembly, generally indicated at 130, is provided in a case or housing 132. An analog display, generally indicated at 134, is part of analog display assembly 130.

In the embodiment where digital display 124 resides above the analog display 134 (e.g. hands 36, 38), an LCD or other digital display arrangement is selected such that the analog display 134 is visible therethrough. Such LCD or other digital display technology is within the purview of one skilled in the art. Here too, it is well known in the art how to program and arrange for controller 100 to control the display of digital information on a digital display of the type disclosed in this alternative embodiment.

Other more well-known features of a digital and/or analog display, such as wiring and/or other mechanical or electrical assemblies are omitted for brevity and because such technology is also well-known in the art.

Operation of the present invention will now be disclosed with particular reference to FIGS. 7-10, each of which respectively illustrates functionality and features of the present invention.

For example, FIGS. 7-10, in combination with the other figures herein, disclose a wearable electronic device 10 comprising at least one analog information indicator (e.g. 36, 38 and/or 39), a digital display 24, 124 for displaying information in a digital manner, as would be understood in the art and illustrated in the figures, at least one actuation mechanism (e.g. M1, M2 and/or M3), coupled to the at least one analog information indicator (e.g. 36, 38 and/or 39 respectively), for rotating the at least one analog information indicator in at least one of a clockwise and counterclockwise direction; and controller 100, operatively coupled to the at least one actuation mechanism and the digital display 24, 124, for coordinating the positioning of the at least one analog information indicator (e.g. 36, 38 and/or 39), based on the information being displayed on the digital display.

To be sure, FIGS. 7-10 are intended to be understood in connection with all the embodiments herein, e.g. whether the analog display is above or below the digital display. That is, other than the alternative of having the analog indicators above or below the digital display, all the features and advantages as explained with respect to FIGS. 7-10 are applicable to both embodiments, i.e. FIGS. 1 and 6, herein.

That is, for example, it might be the case that analog indicators 36, 38 and/or 39 function as time of day indicating hands, e.g. hour, minute, and a fourth hand 39, examples of the function of which is disclosed in U.S. Pat. No. 7,113,450. A second hand 37 may also be provided as illustrated. It should be understood that these configurations are but only examples and the use of the number of hands as shown in the figures are but only examples of the versatility of the present invention as more or less hands are envisioned herein.

As stated above, the advantages of the present application are fully appreciated by the use of just one indicator, e.g. indicator 36, 38 or 39. However, in another preferred embodiment, the present invention will utilize at least two of the analog information indicators, e.g. 36, 38.

Thus from a time T₀ where the indicators 36, 38 may be displaying current time information, e.g. 10:09 (e.g. as illustrated in FIG. 1, 10) it will come a time (e.g. T₁) when the digital display 24, 124 will be utilized to display information in a digital manner. For example, FIG. 7 illustrates device 10 wherein digital display 24, 124 displaying “elapsed time,” “distance traveled” and “calories burned.” Again, actuation of a pusher may initiate any of the modes contemplated herein to cause information to be displayed on the digital display, thus causing and dictating the positioning of the indicators 36, 38 and/or 39 based thereon.

Thus, in accordance with the present invention and upon the display of information on the digital display and as illustrated in FIG. 7, the controller 100 coordinates the positioning of analog information indicators 36, 38 to create at least two (2) sections (e.g. upper and lower) defined by the positions of indicators 36, 38. Indicator hand 39 is likewise moved accordingly. Thus it can be seen, there are several patentable distinctions that can be appreciated by the foregoing, namely, that the controller caused the positioning of the indicator hands based on the information being displayed on the digital display, namely that there is information being displayed in a manner where certain information (e.g. “elapsed time”) is displayed in the upper half of the display and other information (e.g. “distance traveled” and “calories burned”) is displayed in the lower half of the display. Moreover, it is significant that the indicators of the present invention remain positioned within the boundaries of the digital display but that the indicators create sections (e.g. in FIG. 7, being two (2) sections) in a viewable area of the digital display 24, 124.

Thus, in the embodiment of FIG. 7, the at least two (2) sections each provide information to a user of the wearable electronic device. And importantly, the positioning of the at least two analog information indicators 36, 38 are such that they do not overlie or obscure the information being provided on the digital display. Indicator hand 39 likewise does not obscure the information being displayed. That is, and with respect to the exemplary positioning shown in FIG. 7, the positioning of the at least two analog information indicators 36, 38 is coordinated by the controller 100 to point to what would be conventional 3 o'clock and 9 o'clock positions of a watch dial, thereby separating the viewable area of the digital display into delimitated top and bottom sections.

FIG. 8 shows a variant of the versatile functionality of the present invention, in which controller 100 coordinates the positioning of analog information indicators 36, 38 to create right and left sections defined by the positions of indicators 36, 38. Indicator hand 39 is likewise moved accordingly. Here for example, certain information is displayed on the left hand side of the digital display 24, 124 (e.g. that a phone call is being received”) while the right hand side of display 24, 124 displays other information (e.g. caller information). Here again, it is significant that the indicators 36, 38 remain positioned within the boundaries of the digital display but that the indicators create sections (e.g. right and left) in a viewable area of the digital display 24, 124. Likewise, the positioning of the at least two analog information indicators 36, 38 in FIG. 8 are such that they do not overlie or obscure the information being provided on the digital display 24, 124. Indicator hand 39 is does not obscure the information being provided on the digital display. That is and again, with respect to the exemplary positioning shown in FIG. 8, the positioning of indicators 36, 38 (and/or 39) is coordinated by controller 100 to point to what would be conventional 12 o'clock and 6 o'clock positions of a watch dial, thereby separating the viewable area of the digital display into right and left sections.

Reference is thus next made to FIG. 9, which illustrates an advantageous use of a third analog information indicator, whether it be indicator 39 or seconds hand 37. Here again, controller 100 coordinates the positioning of three analog information indicators 36, 38, 39 to create at least three (3) sections defined by the positions thereof, and wherein the three (3) sections are created in the viewable area of the digital display 24, 124. For example, the position of analog information indicators 36, 39 is coordinated by the controller 100 to point to the conventional 9 o'clock and 3 o'clock positions of a watch dial, thereby separating the viewable area of the digital display 24, 124 into top and bottom sections, and controller 100 further coordinates the positioning of analog information indicator 38 to point to a conventional 12 o'clock position of a watch dial, thereby separating the exemplary top section additionally into right and left sections.

It should be understood that the foregoing positions of indicators 36, 38 and 39 are by way of example and not limitation as almost an infinite number of variations are envisioned hereby. Just to name a few, it might be the case that two (2) of the analog information indicators is coordinateable by the controller to point to conventional 12 o'clock and 6 o'clock positions of a watch dial, thereby separating the viewable area of the digital display into right and left sections, and the controller further coordinates the positioning of the third analog information indicator to point to either the 9 o'clock or 3 o'clock position of a watch dial, thereby separating either the right and left section into further top and bottom sections. Alternatively, one or more indicators could point at angles other than 90° with respect to each other, as should now be appreciated. It will also be seen in the exemplary embodiment of FIG. 9 that in a first section the digital display displays the application software being utilized by device 10 to display the message, the upper right-hand section is displaying the person sending the message, while the lower half of the display 24, 124 is displaying the message itself.

Most importantly however, is the fact and the recognition that the indicators 36, 38, 39 are being positioned by controller 100 based on the information being displayed on the digital display. That is, unlike conventional analog/digital watches, nowhere is there description, teaching or suggestion in the prior art to rotate and position the analog indicators/hands based on what is being displayed (i.e. which includes the positioning of the digital information being displayed) on the device 10, 10′. Such a feature allows the indicators 36, 38 and/or 39 to create sections of the digital display defined by the indicator positions, while the indicators themselves act as natural boundaries, while also ensuring that they do not overlie or obscure the information being provided on the digital display. In all of the embodiments, the use of second hand 37 could be used instead of indicator 39 and all references to indicator hand 39 are equally applicable to indicator hand 37.

A further feature of the present invention is the ability for controller 100 to cause, via the controlling of the respective motor(s) M1, M2, M3 and/or M4, the analog information indicators (e.g. 36, 38 and/or 39) to rotate at a desired rate (e.g. faster than a conventional TOD second hand would normally rotate) until the analog information indicators 36, 38 and/or 39 reach(es) its/their respective position(s) at which the indicator(s) would have been had it/they not been positioned based on the information being displayed on the digital display. Alternatively, controller 100 causes the analog information indicator(s) to remain stopped until the indicator(s) (36, 38 and/or 39) is/are at their respective position(s) at which it/they would have been had it not been positioned based on the information being displayed on the digital display.

That is, after the controller 100 causes the indicator(s) 36, 38 and/or 39 to rotate based on the information being displayed on the digital display 24, 124, there will come a time (e.g. after a certain time period, e.g. 3-5 seconds (e.g. in the case of displaying elapsed time and distance (e.g. FIG. 7)) or after a phone call is completed (e.g. in the case of the information of FIG. 8), that the indicators (36, 38 and/or 39) will need to be updated to their respective position(s) at which the indicator(s) would have been had it/they not been positioned based on the information being displayed on the digital display.

Thus, in one preferred embodiment, the indicators will rotate at a faster than normal rate (e.g. faster than a TOD seconds-hand would rotate) until the respective indicators reach its/their position at which it/they would have been had it/they not been repositioned earlier. Moreover, this “true up” rate of rotation of the indicators 36, 38 and/or 39 can easily be selected by one skilled in the art as a matter of design choice. Alternatively, after controller 100 determines that the indicators should return to their “updated” positions, it might be the case that controller 100 maintains the indicators in their “stopped” positions until the indicators are positioned at which it/they would have been had it/they merely continued to rotate at their respective “normal” rates (i.e. prior to be moved under the control of the controller based on the information on the digital display). For example, in the case of a seconds hand 37 being used as an indicator of the present invention(e.g. in place of and/or in addition to indicator 39), the seconds hand could remain stopped until it is positioned at which it is displaying its' accurate/true “seconds” position. Controller 100 then causes the seconds hand to begin rotating again about the display 24, 124 at its normal (e.g. TOD seconds hand rotation) rate, and device 10, 10′ returns to its “normal run” mode. To be sure, in any/all of the foregoing examples, indicator hands 36, 38 and/or 39 may “return” to its normal “true” position at a rate faster (or slower) than the TOD seconds hand rotation rate as would be understood and known in the art. For this reason, the subject matter of U.S. Pat. No. 8,923,096 is incorporated by reference as if fully set forth herein.

Important to the present invention's operability is the fact that controller 100 is able to maintain accurate control of where each of the indicators 36, 37, 38 and/or 39 are and should be positioned (i.e. before and after their re-positioning under the control of controller 100). That is, the controller must maintain and “know” the position to which it must position at the outset and return the indicator(s), whether by acceleration or otherwise, during and after termination of the digital display mode as illustrated in FIGS. 7-9. One skilled in the art would know how to achieve this objective. Again, in these embodiments, one skilled in the art could select a suitable accelerated rate of rotation, as battery and gear ratio constraints, as well as the desired (or acceptable) amount of time to reach their “true up” position, would be considered by the skilled device designer.

Thus, also in accordance with preferred embodiments of the present invention, a method of facilitating the display of information on a digital display of a wearable electronic device is provided, wherein the electronic device comprises at least one analog information indicator; a digital display for displaying information; at least one actuation mechanism, coupled to the at least one analog information indicator, for rotating the at least one analog information indicator in at least one of a clockwise and counterclockwise direction; and a controller, operatively coupled to the at least one actuation mechanism and the digital display, for coordinating the positioning of the at least one analog information indicator based on the information being displayed on the digital display; wherein the method comprises the steps of rotating the at least one analog information indicator in one of a clockwise and counterclockwise direction and positioning said indicator based on the information being displayed on the digital display; wherein at least two (2) sections are created in a viewable area of the digital display; and the position of the at least one analog information indicator is such that it does not overlie or obscure the information being provided on the digital display.

Thereafter, and as discussed above, a preferred method may comprise the step of rotating the at least one information indicator at a rate faster than e.g. a conventional TOD second hand rotates until the at least one analog information indicator reaches its respective position at which the indicator would have been had it not been positioned based on the information being displayed on the digital display. Alternatively, the method may comprise the steps of maintaining the non-rotation of the at least one analog information indicator until it is at a position at which it would have been had it not been positioned based on the information being displayed on the digital display, and thereafter, causing the at least one analog indictor to resume rotation at a rotation rate.

In the preferred embodiments, the motors may be bi-directional stepper motors as appropriate, thus being able to rotate in either direction, and the construction of acceptable stepper motors to functionally operate in this manner are widely available and well within the understanding of those skilled in the art. However, unidirectional motors are also envisioned herein and could be used instead of or in addition to such bi-directional motors. Suitable dials are also well within the purview of the skilled artisan. One skilled in the art would recognize that varying the number of indicators (e.g. display hands) can vary the number of needed stepper motors, all of which is within the scope of the present invention.

Although the preferred embodiments provide that controller 100 is highly integrated wherein all timing and display functionality is controlled by controller 100, alternate embodiments could separate the timekeeping functions from those processing and other functionality, as would be understood by one skilled in the art.

As should also be appreciated by one skilled in the art, the location, position and/or size of the display indicators and/or display hands are merely dictated, for example, by the position of pinions and the position of the respective subassemblies and thus the illustrations herein are shown by example and not limitation.

The gearing ratio to provide for the desirable display rotation or movement of the display hands would be one of design choice depending on the desired or required incremental rotation of the display indicator. Thus the number of wheels in any particular gearing assembly may be more or less than that disclosed herein, and are really one of design choice for the intended function and based upon a number of criterions known to the ordinary designer.

It can thus be seen that the present invention provides for an improved method for and construction of a wearable electronic device that provides for the intentional movement and positioning of the analog information indicator(s) based on the information being displayed on the digital display, all in an effort to maximize the view ability of the information being displayed thereon, to create unobstructed viewing “sections” on the digital display, and improve the overall readability of the information being displayed on the digital display.

As alluded to above, the present invention is applicable for the display of a wide range of information on the digital display 24, 124, and not just the information exemplified above.

Moreover, and for the avoidance of doubt, the advantages of the present invention can be achieved and recognized through the use of only a single hand. Therefore, the present invention contemplates and the figures should be understood to illustrate the present invention being achieved by the use of only one indicator. For example, in FIGS. 7-10, only indicator 36 or 37 or 38 or 39 could be controlled by the controller and positioned based on the information being displayed on the digital display and positioned so as to create at least two (2) sections defined by the position thereof, wherein the at least two (2) sections are created in a viewable area of the digital display. In this way, and depending on the length and/or position of said indicator, the controller coordinates the positioning of the single analog information indicator to create at least two (2) sections defined by the position thereof, wherein the at least two (2) sections are created in a viewable area of the digital display.

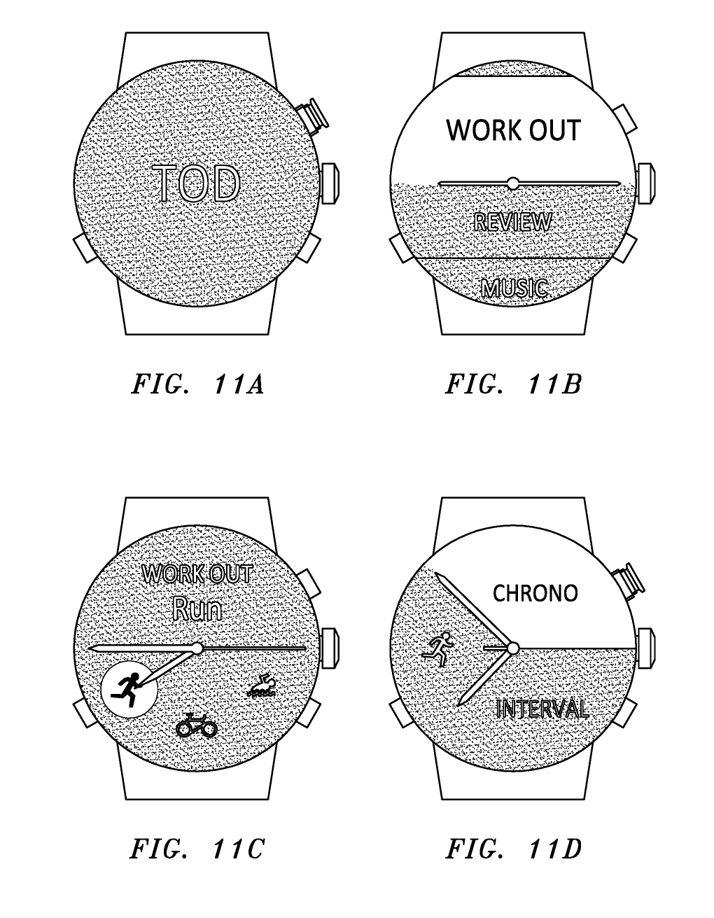

Furthermore, and as an additional feature of the present invention, reference is made to FIGS. 11A, 11B, 11C, 11D which collectively illustrate the use of one or more of the indicators for indicating a certain mode or function out of a plurality of modes or functions in which device 10, 10′ can operate. Wristworn devices having a plurality of available modes within which to operate are well known and described in a multitude of issued patents, such as, but not limited to, U.S. Pat. No. 7,065,006 and the patents described therein. The disclosure of U.S. Pat. No. 7,065,006 and those patents described therein, namely U.S. Pat. Nos. 4,783,773; 4,780,864; 5,555,226; and 4,283,784 are all incorporated by reference as if fully set forth herein.

For example and as shown in FIGS. 11A-11D, since the present invention provides for the display to change depending on e.g. in which mode and/or function the device is operating, device 10, 10′ can cause one or more of the indicators to point at a particular mode/function selection, whether user or controller initiated, e.g. before and/or after confirming the selection.

For example, as shown in the sequence of FIGS. 11A-11D, after the controller coordinates the positioning of the at least one analog information indicator based on the information being displayed on the digital display and coordinates such positioning of the at least one analog information indicator to create at least two (2) sections defined by the position(s) thereof, one (or more) of the hands could then be used to point to one or more selected icons on the display itself to ether allow the user to select a particular mode or function (e.g. activity) or such mode or function or activity could be automatically indicated by the indicator via the controller to indicate to the user which mode/function the device is operating, all of which could assist the user in knowing the mode/function in which he/she is operating. As shown in the figures and as but one example, a user could push the crown to enter or cycle through a “menu” mode (e.g. stopping at the “workout” mode for example (i.e. moving from FIG. 11A to FIG. 11B), push the crown to “select” the “workout” mode and then rotate the crown to scroll through the “workout mode list” wherein the user could select a “run” mode/function, which is indicated by one of the indicators (FIG. 11C), after which the user could further select a “chrono” function or “interval” function in the “run” mode if so desired (FIG. 11D), by way of example and not limitation. It should be again be noted that the indicators need not only point to the 12, 3, 6 or 9 o'clock positions to separate the display into the sections as claimed, as exemplary shown in FIG. 11D, which shows the indictors at various angles to each other (i.e. not limited to 90° or 180°).

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense.

It should also be understood that the following claims are intended to cover all of the generic and specific features of the invention described herein and all statements of the scope of the invention that as a matter of language might fall therebetween.

The present invention is also applicable to a wide variety of devices and applications. That is, while the embodiments disclosed herein have been disclosed with reference to quartz analog timepieces and wristwatches in particular, the scope of the invention is not so limiting.

What is claimed is:

1. A wearable electronic device comprising:
at least one analog information indicator;
a digital display for displaying information;
at least one actuation mechanism, coupled to the at least one analog information indicator, for rotating the at least one analog information indicator in at least one of a clockwise and counterclockwise direction; and
a controller, operatively coupled to the at least one actuation mechanism and the digital display, for coordinating the positioning of the at least one analog information indicator based on the information being displayed on the digital display.

2. The wearable electronic device as claimed in claim 1, comprising at least a second analog information indicator and at least a second actuation mechanism coupled to the at least second analog information indicator; and
wherein the controller coordinates the positioning of the at least two analog information indicators based on the information being displayed on the digital display.

3. The wearable electronic device as claimed in claim 1, wherein the controller coordinates the positioning of the at least one analog information indicator to create at least two (2) sections defined by the position thereof, wherein the at least two (2) sections are created in a viewable area of the digital display.

4. The wearable electronic device as claimed in claim 2, wherein the controller coordinates the positioning of the at least two analog information indicators to create at least two (2) sections defined by the positions thereof, wherein the at least two (2) sections are created in a viewable area of the digital display.

5. The wearable electronic device as claimed in claim 3, wherein the at least two (2) sections each provide information to a user of the wearable electronic device.

6. The wearable electronic device as claimed in claim 4, wherein the at least two (2) sections each provide information to a user of the wearable electronic device.

7. The wearable electronic device as claimed in claim 6, wherein the position of the at least two analog information indicators are such that they do not overlie or obscure the information being provided on the digital display.

8. The wearable electronic device as claimed in claim 7, wherein the positioning of the at least two analog information indicators is coordinatable by the controller to point to conventional 12 o'clock and 6 o'clock positions of a watch dial, thereby separating the viewable area of the digital display into right and left sections.

9. The wearable electronic device as claimed in claim 7, wherein the positioning of the at least two analog information indicators is coordinatable by the controller to point to conventional 3 o'clock and 9 o'clock positions of a watch dial, thereby separating the viewable area of the digital display into top and bottom sections.

10. The wearable electronic device as claimed in claim 8, comprising a third analog information indicator and a third actuation mechanism coupled to the third analog information indicator; and
wherein the controller coordinates the positioning of the at least three analog information indicators based on the information being displayed on the digital display.

11. The wearable electronic device as claimed in claim 10, wherein the controller coordinates the positioning of the at least three analog information indicators to create at least three (3) sections defined by the positions thereof, wherein the at least three (3) sections are created in the viewable area of the digital display.

12. The wearable electronic device as claimed in claim 11, wherein the position of two (2) of the analog information indicators is coordinatable by the controller to point to conventional 9 o'clock and 3 o'clock positions of a watch dial, thereby separating the viewable area of the digital display into top and bottom the sections, and the controller further coordinates the positioning of the third analog information indicator to point to at least one of a conventional 12 o'clock and 6 o'clock position of a watch dial, thereby separating the top section additionally into right and left sections.

13. The wearable electronic device as claimed in claim 1, wherein the controller causes the at least one analog information indicator to rotate at a rate faster than a conventional TOD second hand rotates until the at least one analog information indicator reaches its respective position at which the indicator would have been had it not been positioned based on the information being displayed on the digital display.

14. The wearable electronic device as claimed in claim 1, wherein the controller causes the at least one analog information indicator to remain stopped until the at least one analog information indicator is at a position at which it would have been had it not been positioned based on the information being displayed on the digital display.

15. The wearable electronic device as claimed in claim 1, wherein the controller coordinates the positioning of the at least one analog information indicator to indicate a mode or function selected from a plurality of available modes or functions, respectively.

16. A method of facilitating the display of information on a digital display of a wearable electronic device, wherein the electronic device comprises at least one analog information indicator; a digital display for displaying information; at least one actuation mechanism, coupled to the at least one analog information indicator, for rotating the at least one analog information indicator in at least one of a clockwise and counterclockwise direction; and a controller, operatively coupled to the at least one actuation mechanism and the digital display, for coordinating the positioning of the at least one analog information indicator based on the information being displayed on the digital display; wherein the method comprises the steps of:
rotating the at least one analog information indicator in one of a clockwise and counterclockwise direction and positioning said indicator based on the information being displayed on the digital display;
wherein at least two (2) sections are created in a viewable area of the digital display; and the position of the at least one analog information indicator is such that it does not overlie or obscure the information being provided on the digital display.

17. The method as claimed in claim 16, comprising the step of rotating the at least one information indicator at a rate faster than a conventional TOD second hand rotates until the at least one analog information indicator reaches its respective position at which the indicator would have been had it not been positioned based on the information being displayed on the digital display.

18. The wearable electronic device as claimed in claim 16, comprising the steps of maintaining the non-rotation of the at least one analog information indicator until it is at a position at which it would have been had it not been positioned based on the information being displayed on the digital display, and
thereafter, causing the at least one analog indictor to resume rotation at a rotation rate.

19. The method as claimed in claim 16, comprising the step of rotating the at least one information indicator to indicate a mode or function selected from a plurality of available modes or functions, respectively.
